(19) United States
(12) Patent Application Publication
(10) Pub. No.: US 2009/0009757 A1
(43) Pub. Date: Jan. 8, 2009

(54) Cuvette

(75) Inventors: Kazunori Mototsu, Kobe-shi (JP); Toshihiro Ootani, Kobe-shi (JP); Toshikuni Suganuma, Kobe-shi (JP)

Correspondence Address: BRINKS HOFER GILSON & LIONE, P.O. BOX 10395, CHICAGO, IL, 60610, US

(73) Assignee: Sysmex Corporation

(21) Appl. No.: 11/973,284

(22) Filed: Oct. 5, 2007

(30) Foreign Application Priority Data
Oct. 5, 2006 (JP) 2006-274468

(51) Int. Cl. G01N 21/03

(52) U.S. Cl. 356/246

(57) ABSTRACT

The present invention is to present a cuvette that is able to prevent a liquid splash and dispersion within the cuvette. The cuvette comprises: a body which is essentially cylindrical and has an opening at an upper end; and a bottom part which has a concave inner surface and is connected to a lower end of the body, wherein the inner surface of the bottom part comprises a tapered part whose inner diameter linearly decreases toward a bottom of the cuvette.

### RELATED APPLICATIONS

This application claims priority under 35 U.S.C. § 119 to Japanese Patent Application No. JP2006-274468 filed Oct. 5, 2006, the entire content of which is hereby incorporated by reference.

### FIELD OF THE INVENTION

The present invention relates to a cuvette for use in a sample analyzer which analyzes a sample such as blood (including plasma and serum), urine and the like.

### BACKGROUND

Conventionally, cuvettes of various shapes are known. For example, the cuvette shown in FIG. 1 is disclosed in Japanese Laid-Open Patent Publication No. 2002-196007. The cuvette shown in FIG. 1 is provided with a bottom part with a hemispherical shape, and a cylindrically shaped body part which is connected to the bottom part.

The cuvette shown in FIGS. 2 and 3 is disclosed in Japanese Laid-Open Utility Model Publication No. H6-40848. The cuvette shown in FIGS. 2 and 3 has a square tube shaped center part, and upper and lower parts connected to the center part. The lower part is provided with bottom part which has a spherical inner surface, and a cylindrical body part which is connected to the bottom part.

Above cuvette is automatically transported and used in the analysis of sample through a process of dispensing the sample and a reagent and stirring the sample and the reagent in an analyzer. For example, the top part of the cuvette is gripped and transported by a transporting device which has a hand member capable of gripping the top part of the cuvette. Furthermore, the liquid accommodated within the cuvette is stirred by oscillating the cuvette by a vibration motor provided on the hand member while the hand member grips the cuvette.

When the cuvette of Japanese Laid-Open Patent Publication No. 2002-196007 and Japanese Laid-Open Utility Model Publication No. H6-40848 is oscillated to stir the liquid accommodated within the cuvette, the liquid which flows within the cuvette collides against the inner wall surface of the cuvette and spatters back. The spattering of the liquid and a collision of the liquid which spatters back may generate the liquid splash and dispersion, and thereby the liquid may adhere to the inner wall surface at the top part of the cuvette which is normally untouched by the liquid. The liquid adhering to the inner wall surface in this manner may cause erroneous reaction in a later process. Therefore, it is desired that the liquid splash and dispersion within the cuvette is prevented.

### BRIEF SUMMARY

A first aspect of the present invention is a cuvette for use in a sample analyzer, comprising: a body which is essentially cylindrical and has an opening at an upper end; and a bottom part which has a concave inner surface and is connected to a lower end of the body, wherein the inner surface of the bottom part comprises a tapered part whose inner diameter linearly decreases toward a bottom of the cuvette.

A second aspect of the present invention is a cuvette for use in a sample analyzer, comprising: a body which is essentially cylindrical and has an opening at an upper end; and a bottom part having an inner surface which has an essentially inverted truncated conic shape, and being connected to a lower end of the body.

A third aspect of the present invention is a cuvette for use in a sample analyzer, comprising: a body which is essentially cylindrical and has an opening at an upper end; and a bottom part which has a concave inner surface and is connected to a lower end of the body, wherein the inner surface of the bottom part has an inverted conic shape with a rounded tip.

### BRIEF DESCRIPTION OF THE DRAWINGS

FIG. 1 is a perspective view of a conventional cuvette;

FIG. 2 is a perspective view of another conventional cuvette;

FIG. 3 is a vertical cross section view of the cuvette of FIG. 2;

FIG. 4 is a perspective view of the cuvette of a first embodiment of the present invention;

FIG. 5 is a cross section view including the center axis A-A′ of the cuvette of the first embodiment;

FIG. 6 is a VI-VI′ cross section view of the cuvette of the first embodiment;

FIG. 7 is a VII-VII′ cross section view of the cuvette of the first embodiment;

FIG. 8 is a top view of an immunoanalyzer;

FIG. 9 is a perspective view of the cuvette supplying mechanism of the immunoanalyzer;

FIG. 10 is a top view showing the support table and guide plate of the cuvette supplying mechanism;

FIG. 11 is a perspective view showing the first reaction unit of the immunoanalyzer;

FIG. 12 is a perspective view showing the BF separation unit of the immunoanalyzer;

FIG. 13 is a perspective view showing the stirring unit of the immunoanalyzer;

FIG. 14 is a schematic view illustrating the operation of the BF separation unit of the immunoanalyzer;

FIG. 15 shows the nozzle unit of the immunoanalyzer;

FIG. 16 is a vertical cross section view of a cuvette of a second embodiment of the present invention; and

FIG. 17 is a vertical cross section view of a cuvette of another embodiment of the present invention.

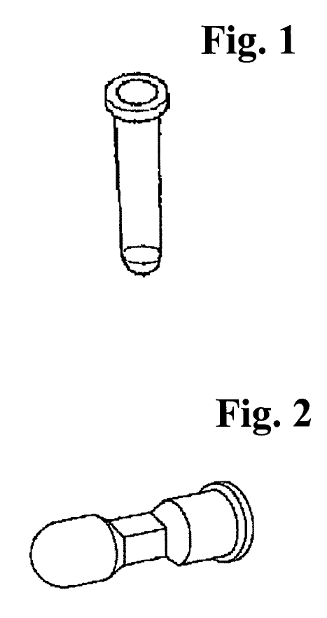

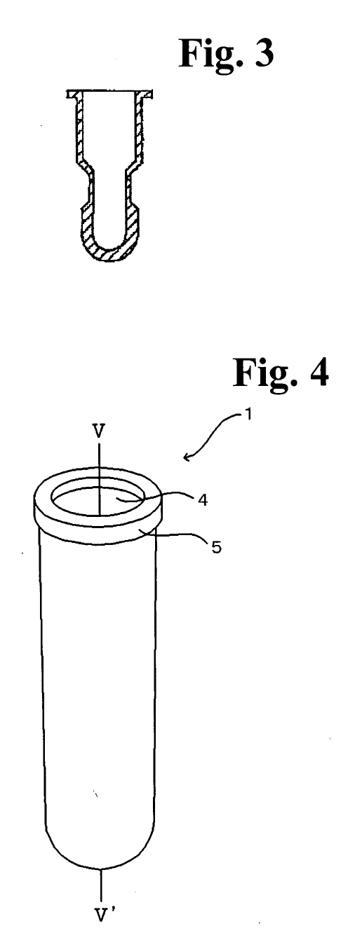

### DETAILED DESCRIPTION OF THE PREFERRED EMBODIMENTS

The embodiments of the present invention are described hereinafter with reference to the drawings.

[Structure of Cuvette 1]

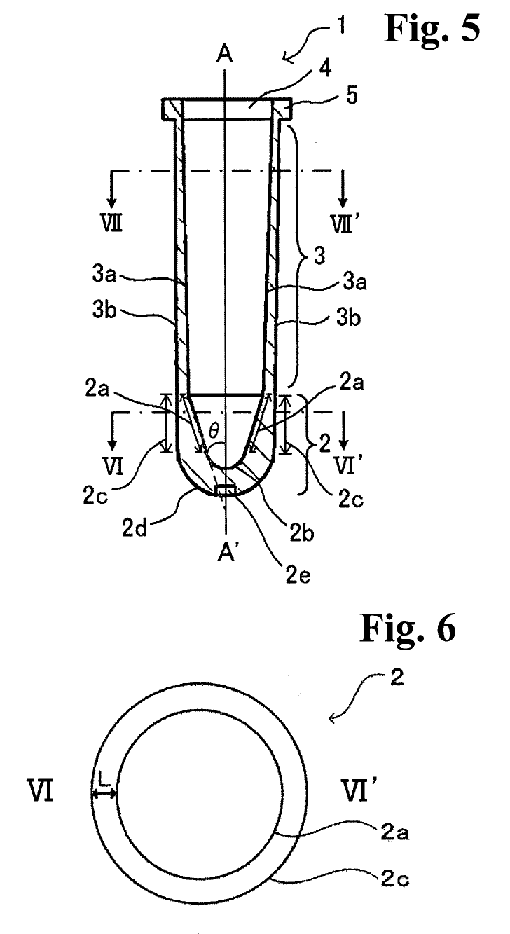

The cuvette 1 of the first embodiment of the present invention is formed of translucent polystyrene in its entirety and is capable of transmitting light. As shown in FIG. 4, the cuvette 1 has an opening part 4 at one end (upper end) and the other end is hemispherically shaped, and outer appearance of the cuvette 1 is cylindrical. Furthermore, an annular flange 5 is provided on a peripheral edge of the opening part 4. FIG. 5 shows a cross section which includes the center axis A-A′ of the cuvette 1 of FIG. 4. As shown in FIG. 5, the cuvette 1 has a bottom part 2, and a body 3 connected to the top of the bottom part 2. The previously mentioned opening part 4 is provided at the upper end of the body 3.

The inner surface of the bottom part 2 is formed in an essentially inverted truncated conic shape which has a rounded tip configured by a sloping surface (tapered part) 2a and an inner bottom surface 2b. The sloping surface 2a is inclined so that the inner diameter of the bottom part 2 becomes linearly smaller toward the inner bottom surface 2b. More specifically, in the cross section which includes the center axis A-A′ of the cuvette 1, the angle (which is formed by the sloping surface 2a and the center axis A-A′ is approximately 18 degrees. Furthermore, the inner bottom surface 2b is essentially formed in a spherical shape, and is configured so that the major diameter of the inner bottom surface 2b is larger than the major diameter of an aspirating tube of the sample analyzer which is to be described later, such that the tip of the liquid aspirating tube is able to make contact with the inner bottom surface 2b. Moreover, the sloping surface 2a and the inner bottom surface 2b are smoothly connected.

The outer surface of the bottom part 2 is configured by an outer side surface 2c which is connected to an outer surface 3b of the body 3, and an outer bottom surface 2d which is connected to the outer side surface 2c. The outer bottom surface 2d has a concavity 2e in the center part thereof, and the outer bottom surface 2d is essentially spherical in shape. The concavity 2e is provided to alleviate deformation of the thick part of the bottom part 2 when forming the cuvette 1. And, the outer side surface 2c has a major diameter which is generally the same along the entirety in a vertical direction. More specifically, although it seems that the outer side surface 2c essentially has a major diameter which is generally the same along the entirety in a vertical is formed in an essentially inverted truncated conic shape the outer side surface 2c actually slopes so that the major diameter of the horizontal cross section of the bottom part 2 becomes somewhat smaller toward the bottom of the cuvette 1. That is, in the cross section that includes the center axis A-A′ of the cuvette 1, the angle formed by the outer side surface 2c and the center axis A-A′ is approximately 0.7 degrees. Moreover, the outer side surface 2c and the outer bottom surface 2d are smoothly connected.

As shown in FIG. 6, the bottom part 2 has an annular cross section at the horizontal cross section of arrow VI-VI′. That is, the cross section shape of the outer surface and inner surface of the bottom part 2 is circular. The thickness L between the sloping surface 2a and outer side surface 2c of the bottom part 2 increases toward the inner bottom surface 2b, since the outer side surface 2c generally has a major diameter which is generally the same along the entirety in a vertical direction while the inner surface of the bottom part 2 is formed in an essentially inverted truncated conic shape and the inner diameter of the sloping surface 2a decreases linearly toward the bottom of the cuvette 1. Therefore, the thickness of the side wall part of the bottom part 2 is greater at the lower end of the bottom part 2 than the side of the body 3.

The body 3 is essentially cylindrical, and has an inner side surface 3a which is connected to the sloping surface 2a of the bottom part 2, and an outer side surface 3b which is connected to the outer side surface 2c of the bottom part 2. The inner side surface 3a of the body 3 slopes so that the inner diameter of the body 3 decreases somewhat toward the bottom of the cuvette 1. Specifically, in the cross section that includes the center axis A-A′ of the cuvette 1, the angle formed by the inner side surface 3a and the center axis A-A′ is approximately 1.6 degrees. In contrast, the outer side surface 3b of the body 3 generally has the same major diameter along the entirety in a vertical direction. More specifically, although it seems that the outer side surface 3b essentially has a major diameter which is generally the same along the entirety in a vertical direction, the outer side surface 3b actually slopes so that the major diameter of the body 3 becomes somewhat smaller toward the bottom of the cuvette 1. That is, in the cross section that includes the center axis A-A′ of the cuvette 1, the angle formed by the outer side surface 3b and the center axis A-A′ is approximately 0.7 degrees. This slope angle is the same as the outer side surface 2c of the bottom part 2. Thus, the slope angle of the inner side surface 3 a relative to the center axis A-A′ is greater that that of the outer side surface 3b. The thickness of the side wall part of the body 3 therefore becomes somewhat larger toward the bottom of the cuvette 1. The difference in thickness depending on the height is quite small, and the side wall part of the body 3 may essentially be viewed as having generally the same thickness along the entirety in a vertical direction.

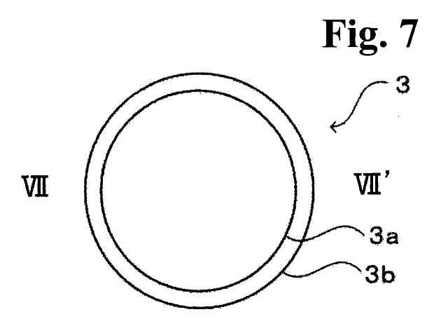

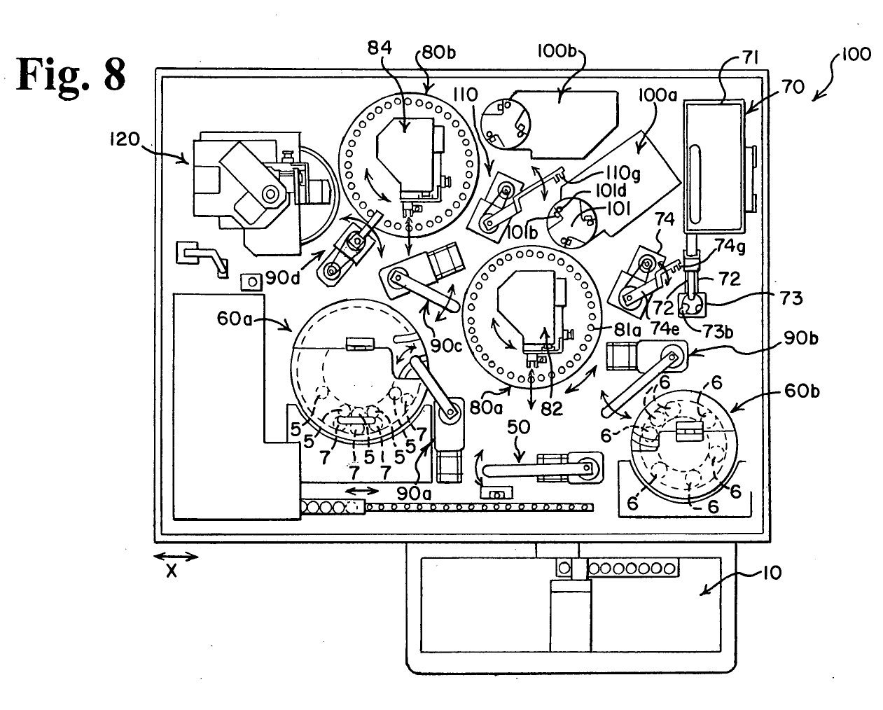

As shown in FIG. 7, the cross section shape of the body 3 is annular in the cross section line VII-VII′ indicated by the arrow. That is, the cross section shape of the outer surface and inner surface of the body 3 is circular. Furthermore, the outer side surface of the bottom part 2 and the outer side surface of the body 3 are inclined at the same angle so as to connect smoothly. The major diameter at the lower end of the body 3 (the end connecting with the bottom part 2) is the same as the major diameter at the upper end of the bottom part 2 (the end connecting with the body 3). Furthermore, the sloping surface 2a of the bottom part 2 and the inner side surface of the body 3 connect with no difference in level. That is, the inner diameter at the lower end of the body 3 and the inner diameter at the upper end of the bottom part 2 are equal.

In the cuvette 1 of the present embodiment, as described above, the inner surface of the bottom part 2 is formed in an essentially inverted truncated conic shape and the sloping surface 2a has an inner diameter that decreases linearly toward the bottom of the cuvette 1. Accordingly, when the cuvette 1 is oscillated to stir the liquid within the cuvette 1, a force acts on the liquid which flows within the cuvette 1 so that the liquid moves upward while swirling in a spiral along the sloping surface 2a of the bottom part 2. Thus, splash and dispersion of the liquid is prevented within the cuvette.

Since the side wall part of the body 3 has a generally uniform thickness along the entirety in a vertical direction, the cuvette 1 is suited for use in making optical measurements of a sample because errors in transmittancy dependent on the height do not occur.

Furthermore, the outer side surfaces of the body 3 and the bottom part 2 of the cuvette 1 have circular cross section shapes at the horizontal cross section. The outer surfaces of the bottom part 2 and the body 3 have smooth surface and are smoothly connected. In a sample analyzer which uses the cuvette 1, therefore, the stability with which cuvettes are supplied is able to be improved because the cuvettes 1 are prevented from jamming within the cuvette supplying device of the sample analyzer, and the cuvettes 1 are prevented from interlocking with one another when the cuvettes 1 are being supplied.

Moreover, the cuvette 1 is able to be gripped and transported using the flange 5 since the flange 5 is provided on the peripheral edge of the opening part 4 of the cuvette 1.

The thickness of the side wall part of the bottom part 2 of the cuvette 1 is formed so as to be greater than the thickness of the side wall part of the body 3, and the thickness of the side wall part of the bottom part 2 is greater on the bottom side than on the top side. Therefore, when the cuvette 1 is oscillated to stir the liquids within the cuvette 1 while the flange 5 of the cuvette 1 is gripped by a cuvette gripping means of the sample analyzer, the cuvette 1 is able to be subjected to greater oscillation since the thick part of the bottom part 2 functions as a weight. As described above, the liquid splash and dispersion is suppressed even when the cuvette 1 is subjected to greater oscillation during stirring since the cuvette 1 is provided with the sloping surface 2a. Furthermore, stirring characteristics are improved by the greater streaming flow when the oscillation is increased. Since the inner side surface 3a of the body 3 of the cuvette 1 slopes so that the inner diameter decreases toward the bottom of the cuvette 1, the liquid within the cuvette 1 rises to the top of the body 3 with the swirling spiral of the liquid. This, therefore, improved the stirring characteristics of the liquid within the cuvette 1.

In the present embodiment, the sloping surface 2a of the bottom part 2 of the cuvette 1 is formed so that the angle (formed by the sloping surface 2a and the center axis A-A′ is approximately 18 degrees in the cross section that includes the center axis A-A′ of the cuvette 1. The angle (is not limited to the approximate 18 degrees, and may be suitably set according to the length and internal diameter of the cuvette and the stirring force applied to the cuvette. However, it is desirable to set the angle (at approximately 10 to 30 degrees, and even more desirable to set the angle (at 13 to 22 degrees to prevent the liquid splash and dispersion within the cuvette when stirring.

When the angle is set at approximately 10 to 30 degrees, a large force is exerted to move the liquid upward within the cuvette during stirring via the sloping surface 2a, such that the liquid rises to a high position within the cuvette along the cuvette inner wall surface. Thus, it is possible to adequately stir the liquid within the cuvette since the liquid therein flows in a great stream within the cuvette. The present inventors obtained exceptionally superior stirring characteristics experimentally when the angle was set between approximately 13 to 22 degrees.

The cuvette 11 of a second embodiment of the preset invention is described below. As shown in FIG. 16, the inner surface of the cuvette 111 essentially forms an inverted truncated conic shape. The outer bottom surface 2d at the lower end of the cuvette 11 has a concavity 12e in the center part thereof, but essentially forms a circular smooth surface. The outer side surface 12c of the cuvette 11 slopes so that the major diameter of the bottom part 12 decreases toward the bottom of the cuvette 1. The horizontal cross section shape of the outer surface of the bottom part 2 is circular. The shape of the cuvette 11 is identical to that of the cuvette 1 with the exception of the outer surface shape of the bottom part 2, which differs. Thus, splash and dispersion of the liquid is able to be prevented within the cuvette, and the stability with which cuvettes are supplied is able to be improved similar to the cuvette 1.

Example of Use of the Cuvette 1 in a Sample Analyzer]

Example of the use of the cuvette 1 of the first embodiment in a sample analyzer is described below.

An immunoanalyzer 100 shown in FIG. 8 is a device which carries out examinations for a variety of items such as hepatitis B, hepatitis C, tumor markers, thyroid hormone and the like using a sample such as blood and the like. As shown in FIG. 8, the immunoanalyzer 100 is configured by a sample transporting unit (sampler) 10, a sample dispensing arm 50, reagent deploying units 60a and 60b, a cuvette supplying device 70, primary reaction unit 80a and secondary reaction unit 80b, reagent dispensing arms 90a, 90b, 90c, and 90d, BF separation units 100a and 100b, carrier unit 110, and detecting unit 120.

In the immunoanalyzer 100, magnetic particles (R2 reagent) are bound to a capturing antibody (R1 reagent) which is bound to an antigen included in a sample such as blood or the like and is the object of the measurement, after which the R1 reagent which includes the unreacted (free) capturing antibody is eliminated by attracting the bound antibody, capturing antibody, and magnetic particles to a magnet 101b of the BF (Bound Free) separator unit 101b. After the antigen which was previously bound to the magnetic particles has been bound to a labeled antibody (R3 reagent), the R3 reagent which includes the unreacted (free) labeled antibody is removed by the magnet of the BF separator 100b which attracts the bound magnetic particles, the antigen, and the labeled antibody. After adding a luminescent substrate (R5 reagent) which luminesces in a reaction process with the labeling antibody, the amount of luminescence generated by the reaction of the labeling antibody and the luminescent substrate is measured by the detecting unit 120. The antigen contained in a sample bound to the labeling antibody can be quantitatively measured in such a process.

First, the cuvettes 1 are sequentially supplied to the primary reaction unit 80a by the cuvette supplying device 70.

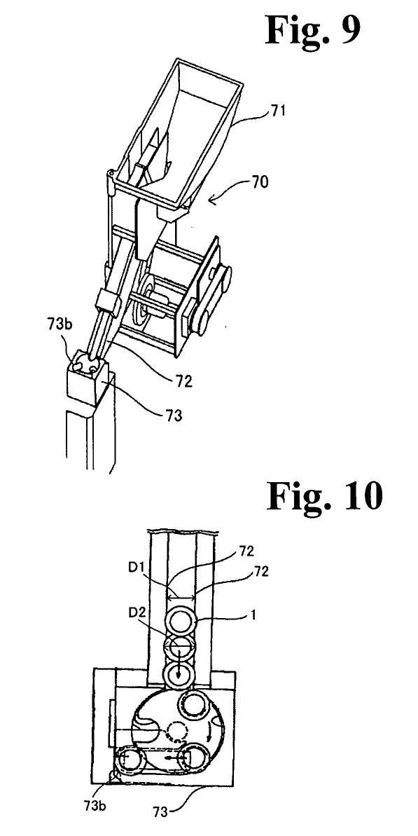

A plurality of cuvettes 1 are accommodated in a hopper 71 of the cuvette supplying device 70 shown in FIG. 9. The cuvettes 1 accommodated in the hopper 71 are moved toward a support platform 73 as the cuvette slides downward on two guide plates 72.

As described above, the outer side surfaces of the body 3 and the bottom part 2 of the cuvette 1 have circular cross section shapes at the horizontal cross section. The outer surfaces of the bottom part 2 and the body 3 form a smoothly connected smooth surface. Therefore, the cuvettes 1 do not snag on the mechanism members of the cuvette supplying device 70 during the cuvette supplying process carried out by the cuvette supplying device 70.

As shown in FIG. 10, the spacing D1 of the guide plates 72 is less than the major diameter D2 of the flange 5, but larger than the major diameter of the body 3. Thus, the cuvette 1 can slide down on the guide plates so to be suspended by the flange 5 on the two guide plates 72.

Furthermore, the body 3 of the cuvette 1 smoothly slides downward since the cuvette 1 can rotate freely while sliding down suspended by the flange 5 on the guide plates 72 by providing the outer side surface 3b with a circular cross section shape in the horizontal cross section.

The cuvette 1 which has been guided by the guide plates 72 is received by the concavity 73b of the support platform 73. The cuvette 1 which has been received by the concavity 73b of the support platform 73 is moved to the holding unit 81a of the primary reaction unit 80a by the catcher unit 74.

When the cuvette 1 is transported to the primary reaction unit 80a by the catcher unit 74, the cuvette 1 is grabbed by the chuck 74g provided on the tip of the arm 74e (refer to FIG. 8) of the catcher unit 74. Since the body 3 of the cuvette 1 is configured so that the outer side surface 3b has a circular cross section shape at the horizontal cross section as described above, at this time the chuck 74g approaches toward the cuvette 1 horizontally and can easily grab the cuvette 1 regardless of the direction the cuvette 1 is facing.

The R1 reagent is dispensed by the reagent dispensing arm 90a into the cuvette 1 which has been supplied to the primary reaction unit 80a. A capturing antibody which bonds to an antigen contained in the sample is included in the R1 reagent. A reagent container 5 which holds the R1 reagent is disposed in the reagent deploying unit 60a.

The sample dispensing arm 50 dispenses into the cuvette 1a sample from within a test tube which has been transported to the aspirating position by the sample transporting unit 10.

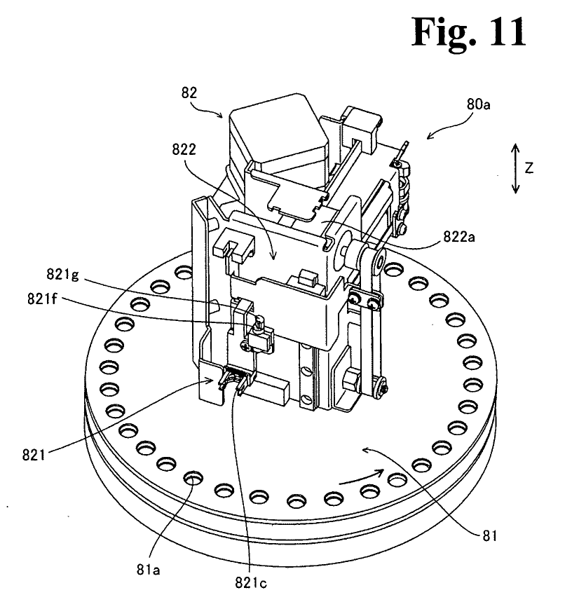

Then, an agitation unit 821, which is provided in the container transporting unit 82 of the primary reaction unit 80a shown in FIG. 11, agitates the cuvette 1 that contains the R1 reagent and the sample. Specifically, a chuck 821c of the agitation unit 821 is deployed opposite the cuvette 1 held by the holding unit 81a of the rotating table 81 by rotating the container transporting unit 82, and the agitation unit 821 of the container transporting unit 82 is moved from the center toward the outer side of the rotating table 81. Thus, the cuvette 1 which contains the sample and the R1 reagent can be grasped by the chuck 821c of the agitation unit 821. Then, the chuck 821c which holds the cuvette 1 is raised by driving the motor 822a of the vertical transport mechanism 822, and thereafter the motor 821f of the agitation unit 821 is driven. Therefore, the R1 reagent and the sample within the cuvette 1 are stirred since the rotary oscillation of the motor 821f and eccentric weight 821g are transmitted to the R1 reagent and the sample within the cuvette 1 held by the chuck 821c.

Next, the reagent dispensing arm 90b dispenses the R2 reagent in the reagent container 6 disposed in the reagent deployment unit 60b into the cuvette 1 into which the sample and R1 reagent were previously dispensed in the primary reaction unit 80a.

The agitation unit 821 of the container transporting unit 82 of the primary reaction unit 80a then agitates the cuvette 1 which contains the sample, R1 reagent and R2 reagents in the same manner as the agitation process of the sample and R1 reagent.

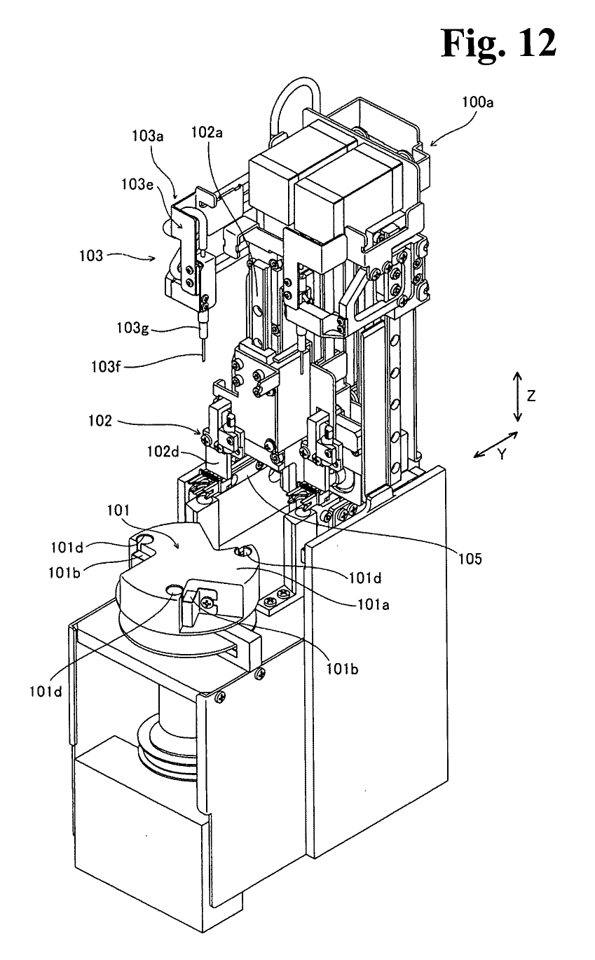

The cuvette 1 which contains the sample, R1 reagent and R2 reagent is then transported to the cuvette hole 101d of the BF separation unit 100a shown in FIG. 12 by the container transporting unit 82 of the primary reaction unit 80a.

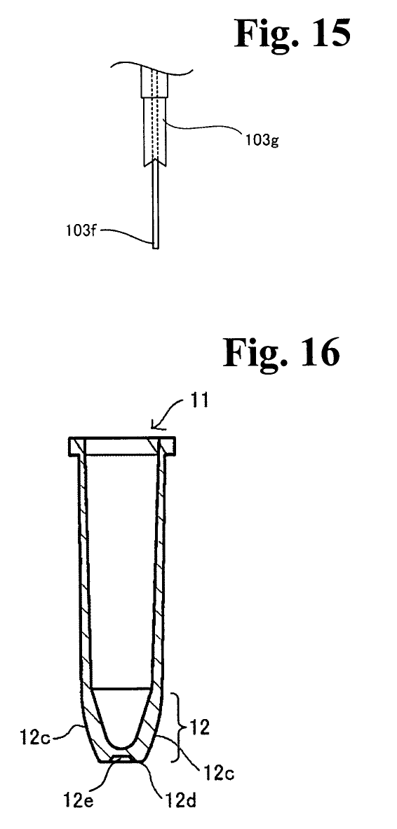

The cuvette 1, which has been placed in the cuvette hole 101d of the deployment unit 101a of the magnetic collector unit 101, is moved in a rotational direction in conjunction with the rotation of the deployment unit 101a, so as to be disposed at a position that corresponds to the agitation unit 102d of the agitation device 102. At this time the magnetic particles within the cuvette 1, which is held in the cuvette hole 101d of the deployment unit 101a, are magnetically collected by the magnet 101b disposed on the side of the cuvette 1. As shown in FIG. 12, the separation device 103 and the agitation device 102 of the BF separation unit 100a are moved forward (Y direction) along the common slide rail 105, and the cuvette 1 is held by the chuck 102h of the agitation unit 102d. As shown in FIG. 14, after an aspirating tube 103f of the nozzle part of the washing unit 103e has been inserted into the cuvette 1, the nonessential components are removed by eliminating the magnetic particles and the antigen bound through the capturing antibody to the magnetic particles by aspirating the sample within the cuvette 1 (first washing process). As shown in FIG. 15, the nozzle part is provided with an aspirating tube 103f for aspirating a liquid within the cuvette 1, and a supplying part 103g for supplying washing liquid into the cuvette 1. Since the inner bottom surface 2b of the cuvette 1 has a diameter which is larger than the major diameter of the aspirating tube 103f, the tip of the aspirating tube 103f is able to make contact with the inner bottom surface 2b so as to sufficiently aspirate the sample within the cuvette 1. In the first washing process, some of the nonessential components are bound to the magnetic particles which are attracted to the magnet 101b of the magnetic collector 101, and some nonessential components remain on the inner wall of the cuvette 1 together with other magnetic particles. Therefore, an agitation process and a second washing process are carried out as described below.

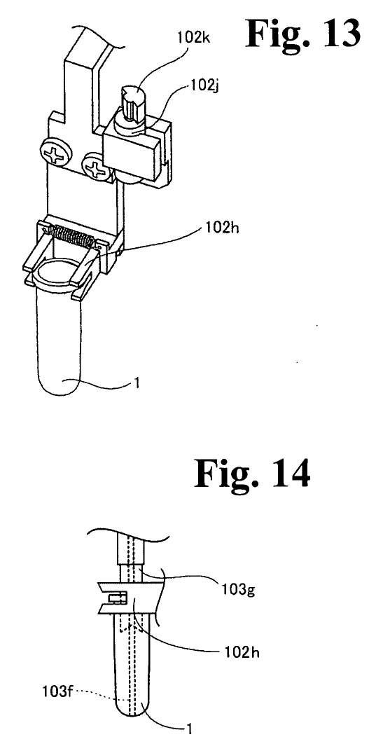

In the BF separation unit 100a, a washing liquid is supplied from the supply unit 103g into the cuvette 1 which is undergoing a first washing process, the cuvette 1 is then agitated. Specifically, in the first washing process the washing liquid is discharged from the supplying unit 103g immediately after aspiration has been performed by the aspirating tube 103f of the separation unit 103a, as shown in FIG. 14. Then, with the cuvette 1 held by the chuck 102h of the agitation unit 102d, the agitation unit 102d is moved upward (Z direction) along the slide rail 102a. As shown in FIG. 13, when the cuvette 1 has been raised, the rotary oscillation of the eccentric weight 102k and the motor 102j is transmitted to the cuvette 1 held by the chuck 102h by actuating the motor 102j, such that the washing liquid, nonessential components, and magnetic particles within the cuvette 1 are agitated. Thus, it is possible to entrap the magnetic particles, and disperse the nonessential components remaining on the inner wall of the cuvette into the washing liquid. Furthermore, the nonessential components adhered to the inner wall of the cuvette 1 can be effectively removed since the liquid containing the washing liquid rises on the sloping surface 2a within the cuvette 1 via the agitation and attains a high position within the cuvette 1.

In the present embodiment, the magnetic particles are collected at the magnet 101b disposed at the side of the cuvette 1 by again holding the cuvette 1 which has been oscillated in the BF separation unit 100a in the cuvette hole 101d of the magnetic collector unit 101. After the magnetic particles have been collected within the cuvette 1, the washing liquid which includes the nonessential components is discharged by the aspiration tube 103f.

The cuvette 1, from which the nonessential components and magnetic particles have been separated by the BF separation unit 100a, is held by the chuck 110g of the catcher unit 110 and transported to the secondary reaction unit 80b.

Then, the reagent dispensing arm 90c aspirates R3 reagent from within the reagent container 7 disposed in the reagent deployment unit 60a, and thereafter discharged the R3 reagent into the cuvette 1 which contains the antigen of the sample and the magnetic particles (R2 reagent) bound through the capturing antibody (R1 reagent). The R3 reagent includes a labeling antibody that binds to the antigen in the sample.

The container transporting unit 84 of the secondary reaction unit 80b, is configured identically to the container transporting unit 82, and the cuvette 1 which contains the R3 reagent that includes the labeling antibody, and the capturing antibody (R1 reagent, antigen (sample), and magnetic particles (R2 reagent), is agitated by the container transporting unit 84 in the same manner as the previously described agitation process for the R1 reagent and the sample.

The cuvette 1, which contains the R3 reagent that includes the labeling antibody, and the capturing antibody (R1 reagent, antigen (sample), and magnetic particles (R2 reagent), is transported to the BF separation unit 100b by the container transporting unit 84 of the secondary reaction unit 80b.

Then, the washing process and agitation process are carried out in the BF separation unit 100b in the same manner as the washing process and the agitation process were previously carried out in the BF separation unit 100a. Thus, the R3 reagent (nonessential component) which includes the labeling antibody that did not bind to the antigen of the sample can be adequately eliminated. Thereafter, the cuvette 1, which contains the sample that includes the antigen bound to the labeling antibody from which nonessential components have been removed, is again transported to the secondary reaction unit 80b by the container transporting unit 84 of the secondary reaction unit 80b.

Then, the reagent dispensing arm 90d discharges R5 reagent, which includes a luminescent substrate and is accommodated in a reagent container not shown in the drawing disposed in the bottom part of the immunoanalyzer 100, into the cuvette 1 which contains the capturing antibody (R1 reagent), magnetic particles (R2 reagent), labeling antibody (R3 reagent), and antigen of the sample. The R5 reagent includes a luminescent substrate that luminesces when reacted with the labeling antibody of the R3 reagent.

The container transporting unit 84 of the secondary reaction unit 80b then oscillates the cuvette 1, which contains the capturing antibody (R1 reagent), antigen (sample), magnetic particles (R2 reagent), labeling antibody (R3 reagent), and R5 reagent that includes the luminescent substrate, in the same manner as the previously described agitation process for the R1 reagent and the sample.

Subsequently, the cuvette 1, which contains the capturing antibody (R1 reagent), antigen (sample), magnetic particles (R2 reagent), labeling antibody (R3 reagent), and R5 reagent that includes the luminescent substrate, is transported to the detecting unit 120, and the amount of luminescence generated by the reaction process of the labeling antibody of the R3 reagent and the luminescent substrate of the R5 reagent is obtained by a photomultiplier (not shown in the drawing), as shown in FIG. 8.

Although the agitation operation is carried out several times before measuring the sample in the immunoanalyzer 100 described above, the reagent splash and dispersion within the cuvette 1 is prevented in each agitation process by using the cuvette 1 of the present embodiment. Therefore, the liquid neither adheres to the top part of the inner surface of the cuvette during agitation, nor contaminates other liquid during agitation in subsequent processes.

The cuvette of the present embodiment has a bottom part which is thicker than the body, as described above. Therefore, the bottom part functions as a weight to greatly stabilize the rotation of the cuvette when the cuvette is oscillated to agitate the liquid within the cuvette which is held below the flange 5. Agitation characteristics of the liquid within the cuvette are therefore improved. Furthermore, since the part below the flange (body) has a circular cross section shape at the horizontal cross section of the outer side surface, when the cuvette is gripped, the part is able to be gripped by the gripping means regardless of the direction in which the cuvette is facing. Although the thick part of the body 3 of the cuvette 1 of the present embodiment gradually increases in thickness from the opening part toward the bottom part, the thickness may also be uniform. Although the inner side surface 3 a of the body of the cuvette 1 is inclined relative to the center axis A-A′ as shown in FIG. 5, the inner side surface 3a may also be parallel to the center axis A-A′.

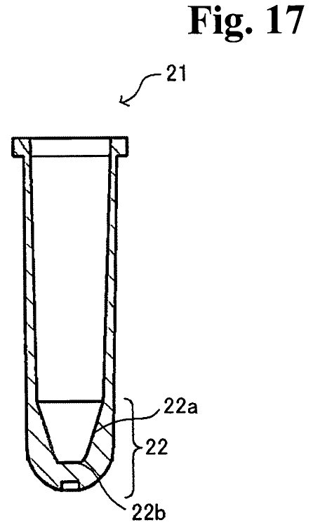

The previously described cuvettes 1 and 11 are provided with a sloping surface that linearly reduces the inner diameter toward the bottom of the cuvette, and a bottom part that has a spherically shaped inner bottom surface. However, the cuvettes 1 and 11 may also be configured with an inner surface which includes a sloping surface 22a that linearly reduces the inner diameter toward the bottom of the cuvette, and a planar circular inner bottom surface 22b, such as the bottom part 22 of the cuvette 21 shown in FIG. 17. That is, the effect of the present invention is able to be obtained when the inner surface of the bottom part is an essentially inverted truncated circular conic surface whether the inner bottom surface of the bottom part of the cuvette is spherical or planar.

Insofar as the body of the cuvette has an essentially cylindrical shape, the body of the cuvette of the present embodiment may also be a cuvette which having a slight step midway on the outer side surface of the body but with an essentially cylindrical shape. Furthermore, the cuvette need not be strictly cylindrical, such as a square columnar cuvette which has a small interior angle enough to consider the cuvette a cylindrical shape, may also be an essentially cylindrical shape.

Although the immunoanalyzer has been described by way of example as an analyzer using the cuvette of the present embodiment, the present invention is not limited to use in an immunoanalyzer, and may be generally used in sample analyzers which use cuvettes such as biochemical analyzers, blood coagulation measuring devices and the like.

What is claimed is:

1. A cuvette for use in a sample analyzer, comprising:
a body which is essentially cylindrical and has an opening at an upper end; and
a bottom part which has a concave inner surface and is connected to a lower end of the body,
wherein the inner surface of the bottom part comprises a tapered part whose inner diameter linearly decreases toward a bottom of the cuvette.

2. The cuvette of claim 1, wherein
the inner surface of the bottom part comprises the tapered part and an inner bottom surface, and
the inner bottom surface has a spherical shape or a planar shape.

3. The cuvette of claim 2, wherein
the inner bottom surface has the spherical shape, and
the tapered part and the inner bottom surface are smoothly connected.

4. The cuvette of claim 1, wherein
the tapered part is connected to an inner surface of the body, and
the lower end of the body has an inner diameter equal to an inner diameter of an upper end of the tapered part.

5. The cuvette of claim 1, wherein
the bottom of the cuvette has an essentially hemispherical outer shape.

6. The cuvette of claim 1,
wherein the bottom part has an outer surface comprising an outer side surface and an outer bottom surface connected to the outer side surface,
wherein the outer side surface is tapered so that an outer diameter of the bottom part decreases toward the bottom of the cuvette, and
wherein the outer bottom surface is essentially planar.

7. The cuvette of claim 1, wherein
the body has an inner surface which is tapered so that an inner diameter of the body decreases toward the bottom part.

8. The cuvette of claim 1, wherein
in a cross section which includes an axis from a center of the opening to the bottom part, an angle formed by the axis and the tapered part is 10 to 30 degrees.

9. The cuvette of claim 2,
wherein the sample analyzer comprises an aspirating tube for aspirating a liquid contained in the cuvette, and
wherein the inner bottom surface has an inner diameter which allows a tip of the aspirating tube to contact with the inner bottom surface when the aspirating tube is inserted into the cuvette.

10. The cuvette of claim 1, wherein
the body comprises a flange on a peripheral edge of the opening.

11. The cuvette of claim 1, wherein
the bottom part has a thickness greater than a thickness of the body.

12. A cuvette for use in a sample analyzer, comprising:
a body which is essentially cylindrical and has an opening at an upper end; and
a bottom part having an inner surface which has an essentially inverted truncated conic shape, and being connected to a lower end of the body.

13. The cuvette of claim 12,
wherein the inner surface of the bottom part comprises a tapered part and an inner bottom surface,
wherein the tapered part has an inner diameter linearly decreasing toward a bottom of the cuvette, and
wherein the inner bottom surface has a spherical shape or a planar shape.

14. The cuvette of claim 13, wherein
the inner bottom surface has the spherical shape, and
the tapered part and the inner bottom surface are smoothly connected.

15. The cuvette of claim 13, wherein
the bottom of the cuvette has an essentially hemispherical outer shape.

16. The cuvette of claim 12, wherein
the body has an inner surface which is tapered so that an inner diameter of the body decreases toward the bottom part.

17. The cuvette of claim 12, wherein
the bottom part has a thickness greater than a thickness of the body.

18. A cuvette for use in a sample analyzer, comprising:
a body which is essentially cylindrical and has an opening at an upper end; and
a bottom part which has a concave inner surface and is connected to a lower end of the body,
wherein the inner surface of the bottom part has an inverted conic shape with a rounded tip.

19. The cuvette of claim 18, wherein
the body has an inner surface which is tapered so that an inner diameter of the body decreases toward the bottom part.

20. The cuvette of claim 18, wherein
the bottom part has a thickness greater than a thickness of the body.
